(19) United States
(12) Patent Application Publication
(10) Pub. No.: US 2020/0111137 A1
(43) Pub. Date: Apr. 9, 2020

(54) SERVER DEVICE AND INFORMATION DISPLAY METHOD

(71) Applicant: PANASONIC INTELLECTUAL PROPERTY MANAGEMENT CO., LTD., Osaka (JP)

(72) Inventors: Kenjiro TSUDA, Kanagawa (JP); Kenji TAKAHASHI, Kanagawa (JP); Nozomi YOSHIHARA, Kanagawa (JP)

(73) Assignee: PANASONIC INTELLECTUAL PROPERTY MANAGEMENT CO., LTD., Osaka (JP)

(21) Appl. No.: 16/617,832

(22) PCT Filed: Apr. 3, 2018
(86) PCT No.: PCT/JP2018/014193

§ 371 Date: Nov. 27, 2019

(30) Foreign Application Priority Data
Jun. 27, 2017 (JP) 2017-124958

(51) Int. Cl. G06Q 30/06; G06Q 30/02

(52) U.S. Cl. CPC G06Q 30/0601; G06Q 30/0251

(57) ABSTRACT

In a case where a server device is connected to be communicable with a communication terminal carried by each of a plurality of users and a plurality of users perform, in the time series, a plurality of behaviors until the plurality of users purchase or register the commodity or service in an actual facility or virtual facility, the server device includes an acquiring unit acquiring information on a behavior of the plurality of users for each touch point corresponding to a point in time of at least one of the plurality of behaviors, and a communicator outputting and transmitting information on a behavior of the plurality of users at each of the touch points so as to display along a time series on a monitor.

### TECHNICAL FIELD

The present disclosure relates to a server device communicably connected to a communication terminal and an information display method using the server device.

### BACKGROUND ART

Conventionally, in order to guide customers to a store facility to attract many customers, for example, a communication terminal such as a smartphone carried by a customer is notified of commodity information (so called push notification). In addition, in order to increase a sale in the store facility, for example, a coupon including discount information on a commodity is distributed to the communication terminal of the customer (so called coupon distribution) so as to awake purchase motivation of the commodity in the store to the customer who actually enters the store facility.

Here, for example, a point system in PTL 1 has been proposed as prior art to acquire customers who actually visit the store by adding incentives to a consumption behavior of the customer.

### CITATION LIST

### Patent Literature

PTL 1: Japanese Patent Unexamined Publication No. 2003-288521

### SUMMARY OF THE INVENTION

However, in the related art as disclosed in PTL 1, it has not been taken into consideration that at least a part of process, such as a time-series behavior, of how a plurality of customers are awakened to purchase a commodity or service and how the plurality of customers purchase or register the commodity or service is visually shown. Therefore, it is hard to analyze the process, such as a time-series behavior, of how the plurality of customers purchase or register the commodity or service.

The present disclosure has been made in consideration of the circumstances of the related art, and an object thereof is to provide a server device and an information display method for visually showing an analysis result of at least a part of a process such as a time-series behavior of which a plurality of customers purchase or register a commodity or service and enhancing convenience for analysis of the process such as a behavior of the plurality of customers.

The present disclosure provides a server device including: a selector setting a plurality of touch points corresponding to a point in time when a plurality of behaviors of a plurality of users who purchase or register a commodity or service in an actual facility occur; a communicator transmitting information on the commodity or service to a communication terminal carried by each of the plurality of users at at least one of the plurality of touch points; an acquiring unit acquiring information on a behavior of the plurality of users and information on a behavior of the plurality of users with respect to the information on the commodity or service for each of the plurality of touch points; and a display screen generator arranging the plurality of touch points in a time series and generating a display screen displaying information on a behavior of the plurality of users for each of the plurality of touch points arranged in a time series, the information on the behavior of the plurality of users being acquired for each of the plurality of touch points and including the information on a behavior of the plurality of users with respect to the information on the commodity or service.

The present disclosure provides an information display method in a server device which is communicable with a communication terminal carried by each of a plurality of users, the method including: setting a plurality of touch points corresponding to a point in time when a plurality of behaviors of a plurality of users who purchase or register a commodity or service in an actual facility occur; transmitting information on the commodity or service to the communication terminal carried by each of the plurality of users at at least one of the plurality of touch points; acquiring information on a behavior of the plurality of users and information on a behavior of the plurality of users with respect to the information on the commodity or service for each of the plurality of touch points; and arranging the plurality of touch points in a time series and generating a display screen displaying information on a behavior of the plurality of users for each of the plurality of touch points arranged in a time series, the information on the behavior of the plurality of users being acquired for each of the plurality of touch points and including the information on a behavior of the plurality of users with respect to the information on the commodity or service.

According to the present disclosure, the analysis result of at least a part of the process such as a time-series behavior of which the plurality of customers purchase or register the commodity or service can be visually shown and the convenience for analysis of the process such as behaviors of the plurality of customers can be enhanced.

### BRIEF DESCRIPTION OF DRAWINGS

FIG. 1 is a view illustrating an example of a schematic configuration of a marketing solution system according to respective embodiments.

FIG. 2 is a block diagram illustrating an example of an internal configuration of a portal server according to a first embodiment.

FIG. 3 is a view illustrating an example of registration contents of a log information management DB.

FIG. 4 is a view schematically illustrating an example of an operation procedure for providing a service in the marketing solution system.

FIG. 5A is a view illustrating a push notification setting screen displayed on a monitor.

FIG. 5B is a view illustrating a coupon distribution setting screen displayed on a monitor.

FIG. 5C is a view illustrating an analysis result screen displayed on a monitor.

FIG. 5D is a view illustrating an analysis result screen displayed on a monitor.

FIG. 6 is a view illustrating an example of an overview of the marketing solution system.

FIG. 7 is a view illustrating a UI screen displayed on a monitor of a customer company terminal.

FIG. 8 is a view illustrating another UI screen displayed on a monitor of a customer company terminal.

FIG. 9 is a view illustrating still another UI screen displayed on a monitor of a customer company terminal.

FIG. 10 is a view illustrating still another UI screen displayed on a monitor of a customer company terminal.

FIG. 11 is a view illustrating still another UI screen displayed on a monitor of a customer company terminal.

FIG. 12 is a view illustrating still another UI screen displayed on a monitor of a customer company terminal.

FIG. 13 is a block diagram illustrating an example of a detailed internal configuration of a portal server according to a second embodiment.

FIG. 14 is a block diagram illustrating an example of an internal configuration of a portal server according to a third embodiment.

FIG. 15 is a view illustrating an example of an analysis result screen comparatively showing the number of store information accesses, a coupon utilization status, and a coupon providing status in May.

### DESCRIPTION OF EMBODIMENTS

### Background of Related Art According to Respective Embodiments

A customer company operation manager who provides a service such as push notification or coupon distribution to a communication terminal carried by a customer performs various input operations to an own terminal (for example, personal computer (PC)) connected to a portal server. In this input operation, the customer company operation manager displays a push notification setting screen and sets contents of the push notification, or displays a coupon distribution setting screen and sets contents of the coupon distribution.

Further, the above-described point system in PTL 1 collates and analyzes advertisement view information and store visit information or purchase information to calculate and give an incentive point in a case where a customer, who collects information from an advertisement or views the advertisement, visits a company or store which has already joined the point system, and purchases a commodity or service. Thus, the system can smoothly follow a flow from an advertising viewing behavior by the customer who collects the information in advance to a consuming behavior by the customer who actually visits the company or store and purchases the commodity or service. Thereby, the system can provide the preferential treatment only with a customer who, not only viewed the advertisement, but also has been an actual purchaser or an actual visitor having a possibility to be the actual purchaser.

Hereinafter, respective embodiments specifically describing a server device and an information display method according to the present disclosure will be described in detail with reference to the accompanying drawings. However, unnecessarily detailed description may be omitted. For example, there may be omitted the duplicate description of already well detailed descriptions of known matters substantially the same structure. This is to prevent the following description from being unnecessarily redundant, in order to facilitate the understanding of those skilled in the art. Incidentally, the accompanying drawings and the description below are provided in order that those skilled in the art will fully understand the present disclosure, and there are is no intention to limit the subject matter recited in the claims by these.

Hereinafter, a portal server providing various services (hereinafter, referred to as a “digital marketing solution service”) by a facility operator (hereinafter, referred to as “customer company”) who operates a commercial facility such as a shopping mall composed of a plurality of stores will be described as an example of the server device according to the present disclosure. For convenience of explanation, the following is explained under an assumption that the portal server is used for the operation of a commercial facility in a shopping mall, or the like, but is not limited and applied to the commercial facility. For example, the portal server may be used for the operation of public facilities such as an art museum, a museum, and the like or may be used for the operation of virtual facilities such as an online shopping website.

First of all, terms used in a digital marketing solution service in respective embodiments will be described.

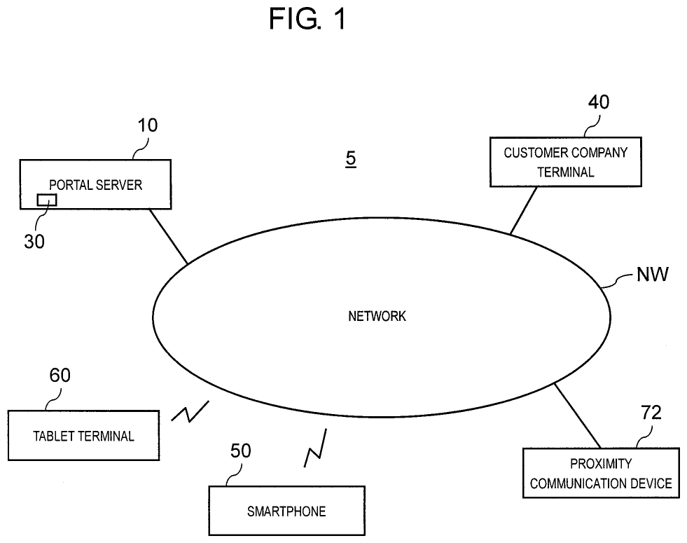

The marketing solution system represents an information system for providing a digital marketing solution service of respective embodiments, and the specific configuration of the system is illustrated in FIG. 1.

Customer journey is a process of customer's “behavior”, “thought”, and “feeling” until the customer using the marketing solution service recognizes the commodity or service and finally purchases or registers the utilization thereof. In particular, we interpret the time-series order (course) about how the customer recognizes and interact with commodity or service of a brand and motivated to purchase the commodity or register the utilization of the service, as a journey. And, we call the visualized behavior and psychology of customer in the time series, as “customer journey map”.

A touch point refers to a generation timing (a time point of generation) of various events until the customer purchases the commodity or registers the utilization of the service in the time series of the customer journey map. That is, at the touch point, transmission and reception of information or data occurs between the portal server of the customer company and the communication terminal such as a smartphone or tablet terminal carried by the customer in one-way or two-way direction.

In addition, a proximity communication device (an example of an information communication device) which performs the transmission and reception of information or data is installed in the shopping mall or store by using short range communication at the touch point after the customer enters the shopping mall or after the customer enters each store in the shopping mall. Visible light communication of, for example, communication by a beacon terminal, near field communication (NFC), or LinkRay (registered trademark), is used for the short range communication.

The beacon terminal transmits a signal including information or data using Bluetooth (registered trademark) Low Energy (BLE) which is a communication standard, for example. The beacon terminal transmits the signal including the information or data once every few seconds within a range of from several tens of centimeters radius to several tens of meters radius with an installation position of the own terminal as a starting point.

LinkRay (registered trademark) is a name of a service which rapidly receives a visible light signal (specifically, a signal generated by superimposing information or data to be transmitted) using a camera (not illustrated) mounted on the smartphone or tablet terminal and a dedicated application, the visible light signal being generated by flickering a light emitting diode (LED) light source rapidly, The dedicated application is previously installed so as to be executable on the smartphone or tablet terminal. According to LinkRay (registered trademark), the customer holds the smartphone or tablet terminal to the LED light source which is a service object of LinkRay ( registered trademark), such that the smartphone or tablet terminal can acquire the information or data transmitted from the LED light source. Here, in the service of LinkRay (registered trademark), the detailed description of a process in which the smartphone or tablet terminal acquires the information or data transmitted from the LED light source will be omitted.

In addition, two-dimensional barcodes such as QR codes (registered trademark) which can be read by a communication terminal such as a smartphone or tablet terminal are arranged in the shopping mall or store at the touch point corresponding to a point in time after the customer enters the shopping mall or after the customer enters each store in the shopping mall. The communication when reading the two-dimensional barcodes may also be included in the short range communication described above.

### First Embodiment

FIG. 1 is a view illustrating an example of a schematic configuration of marketing solution system 5 according to respective embodiments. Marketing solution system 5 includes portal server 10, customer company terminal 40, smartphone 50, tablet terminal 60, and proximity communication device 72. Portal server 10, customer company terminal 40, smartphone 50, tablet terminal 60, and proximity communication device 72 are connected to one another through network NW.

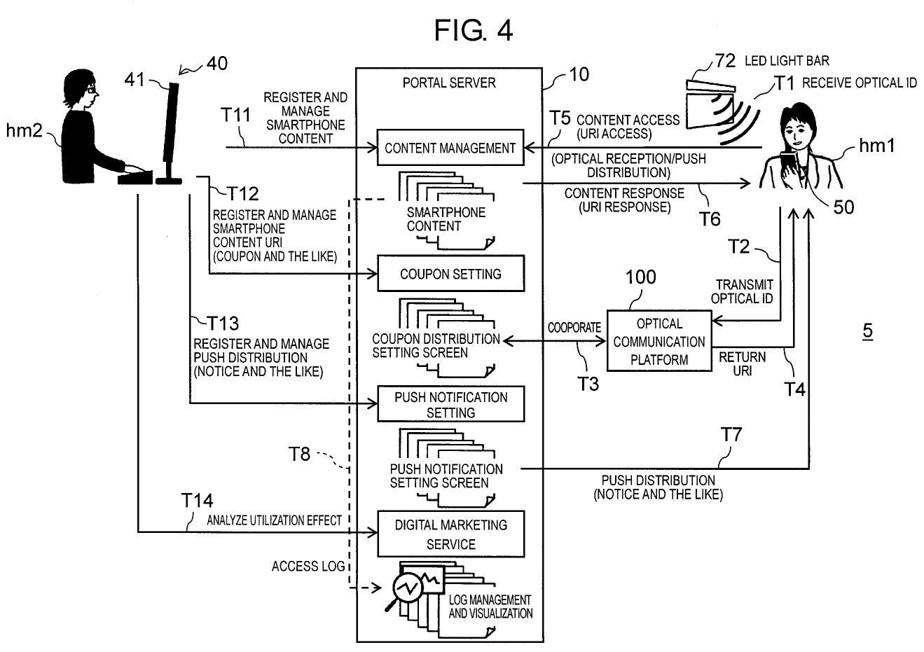

Network NW may be a wired network, a wireless network, or a combination of the wired network and the wireless network. For example, network NW is a communication network such as the Internet, a wired local area network (LAN), a wireless LAN, or the like. In addition, network NW may be a dedicated network such as an intranet that can be used in a shopping mall, for example. Optical communication platform 100 (see FIG. 4) for performing visible light communication such as LinkRay (registered trademark) is constructed on network NW.

Portal server 10 (server device) is a cloud server providing a digital marketing solution service and has log information management database (DB) 30 in which various log information (described below) are registered.

Customer company terminal 40 is a computer which is used by an operation manager of a facility operator (customer company) who operates a commercial facility such as a shopping mall, and is constituted using, for example, a desktop personal computer (PC), a note type PC, a tablet terminal, and the like.

Each of smartphone 50 and tablet terminal 60 is a communication terminal which provides the digital marketing solution service of respective embodiments and is used by a general user such as a customer.

Proximity communication device 72 (an example of information communication device) is disposed in the shopping mall or store as described above, performs short range communication with smartphone 50 or tablet terminal 60, and when short range communication device 72 identifies the presence of smartphone 50 or tablet terminal 60 by the short range communication, short range communication device 72 notifies the presence thereof to portal server 10.

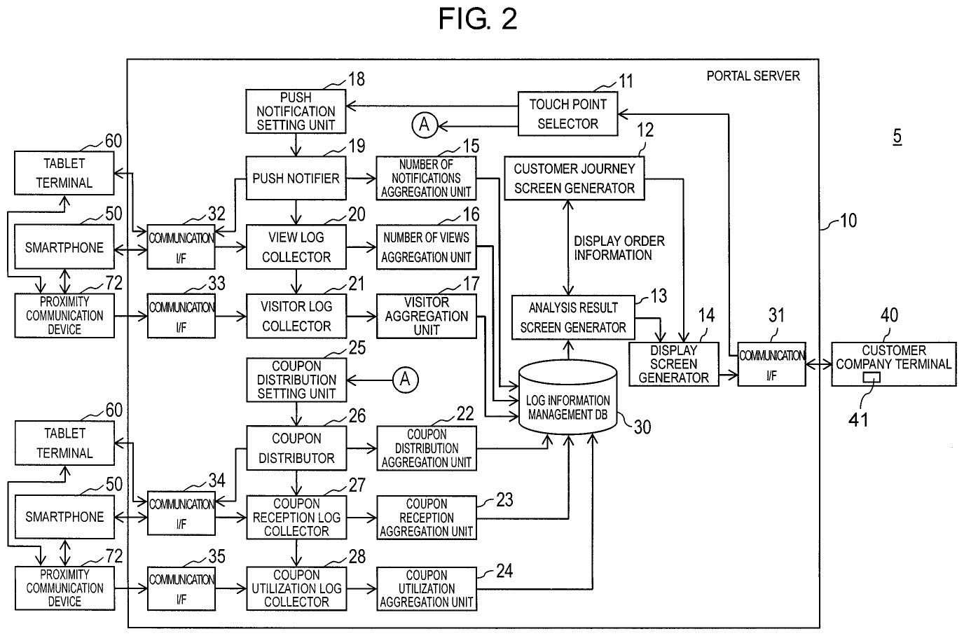

FIG. 2 is a block diagram illustrating an example of a detailed internal configuration of portal server 10 according to a first embodiment. Portal server 10 includes push notification setting unit 18, push notifier 19, view log collector 20, visitor log collector 21, number of notifications aggregation unit 15, number of views aggregation unit 16, visitor aggregation unit 17, and communication interfaces (I/Fs) 32 and 33.

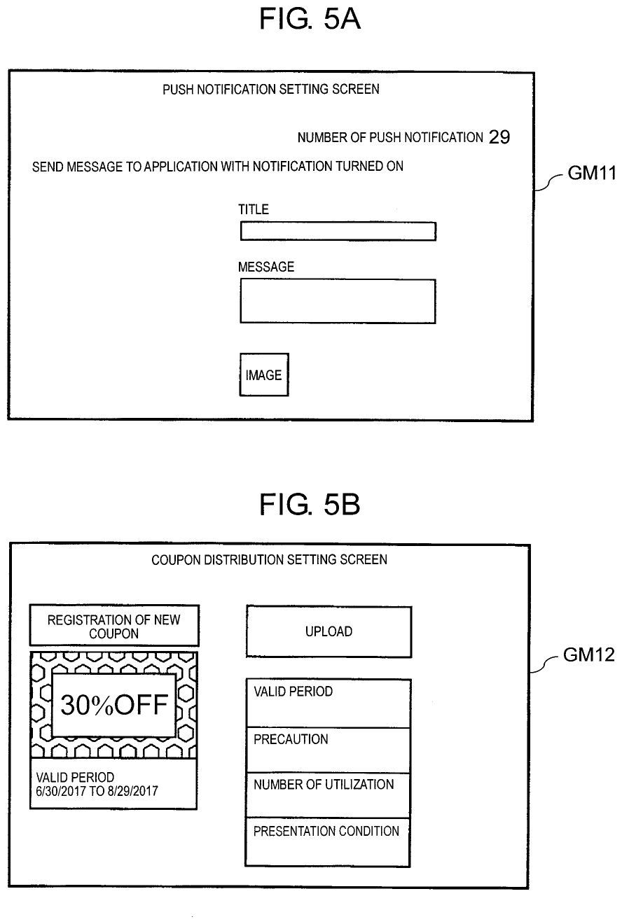

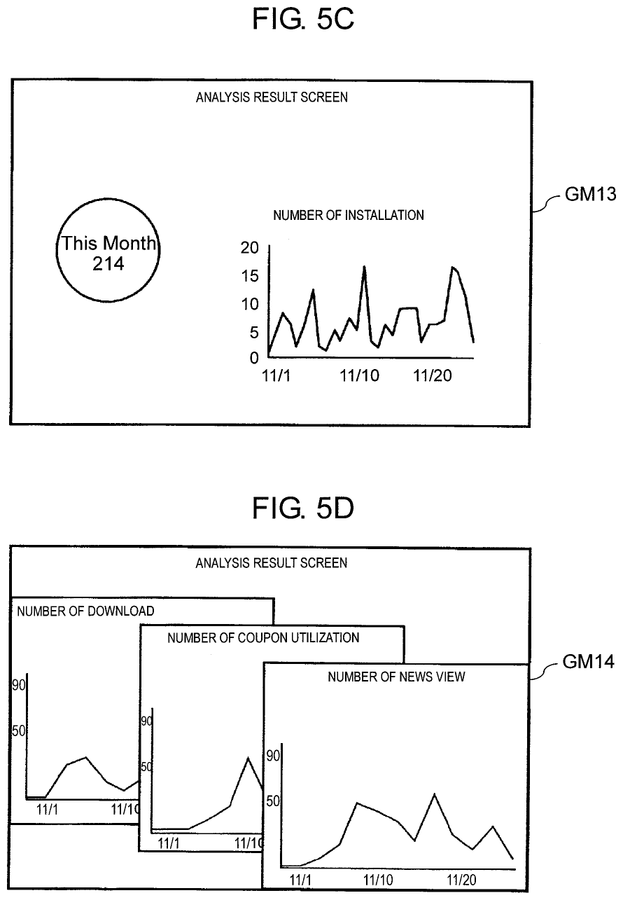

Push notification setting unit 18 sets various setting items such as functions or contents of push notification to push notification setting screen GM11 (see FIG. 5A) displayed on monitor 41 according to a setting operation of customer company operation manager hm2.

Push notifier 19 (information notifier) performs a push notification (including a geo-push notification) to smartphone 50 or tablet terminal 60 carried by each customer through communication I/F 32 according to the setting items set by push notification setting unit 18. Push notifier 19 sends information on smartphone 50 or tablet terminal 60 subjected to the push notification (for example, the number of smartphones or tablet terminals, and a user ID corresponding to smartphone 50 or tablet terminal 60 and capable of identifying a customer. The same hereinafter.) to each of number of notifications aggregation unit 15 and view log collector 20, for every push notification.

The push notification is performed on smartphone 50 or tablet terminal 60 of the customer who is likely to be interested in a commodity or service by the store in a planned manner (for example, by specifying a time), and is a notification of guide information on commodity or service, or the like. An object to be notified may be all customers registered in advance or a part of customers based on attributes such as an age or gender (for example, satisfying a predefined condition using attributes such as an age or gender). Information on a time is included in the setting items of the push notification. In addition, a geo-push notification is a push notification which is performed when smartphone 50 or tablet terminal 60 capable of acquiring positional information on the own terminal enters a predetermined area using a position measuring function such as a global positioning system (GPS), or the like. Information on the predetermined area is included in the setting items of the push notification.

Number of notifications aggregation unit 15 (acquiring unit) aggregates the number of smartphones 50 or tablet terminals 60 as an object to be subjected to push notification (that is, the number of smartphones 50 or tablet terminals 60 subjected to the push notification) as cumulative information on a behavior of a plurality of customers (users), based on the information (see above) acquired from push notifier 19. Number of notifications aggregation unit 15 stores information on the aggregation results (for example, the number of aggregations and a user ID corresponding to smartphone 50 or tablet terminal 60 and capable of identifying a customer. The same hereinafter.) in log information management DB 30.

View log collector 20 collects log information indicating that the customer has viewed the guide information subjected to the push notification through communication I/F 32. View log collector 20 sends, to each of number of views aggregation unit 16 and visitor log collector 21, information on the number of smartphone 50 or tablet terminal 60 on which the guide information or the like subjected to the push notification is viewed in smartphone 50 or tablet terminal 60 which is an object to be subjected to the push notification, based on the log information and information acquired from push notifier 19. In a case where the guide information or the like subjected to the push notification is viewed on the smartphone 50 or tablet terminal 60 by the customer (in other words, the guide information or the like is displayed on a display of smartphone 50 or tablet terminal 60), the log information indicating that the guide information or the like subjected to the push notification has been viewed is sent to portal server 10.

Number of views aggregation unit 16 (acquiring unit) aggregates the number of smartphones 50 or tablet terminals 60 on which the guide information or the like subjected to the push notification is viewed (in other words, the number of views of customer who views the guide information or the like subjected to the push notification) as cumulative information on a behavior of the plurality of customers (users), based on the information (see above) acquired from view log collector 20. Number of views aggregation unit 16 stores information on the aggregation results (for example, the number of aggregations, and a user ID corresponding to smartphone 50 or tablet terminal 60 and capable of identifying a customer. The same hereinafter.) in log information management DB 30.

Visitor log collector 21 collects log information indicating that the customer who visits a shopping mall or store (in other words, identifies smartphone 50 or tablet terminal 60 identified by short range communication by proximity communication device 72) is confirmed by proximity communication device 72 through communication I/F 33. In addition, visitor log collector 21 determines whether or not the customer whose visit to the shopping mall or store is confirmed by proximity communication device 72 is a customer who has viewed the guide information or the like subjected to the push notification, based on information (see above) acquired from view log collector 20. Visitor log collector 21 sends, to visitor aggregation unit 17, information on the number of customers whose visit to the shopping mall or store is confirmed by proximity communication device 72 or information on the number of customers who have viewed the guide information or the like subjected to the push notification among the customers whose visit to the shopping mall or store is confirmed by proximity communication device 72, based on the log information or the log information and determination result which are described above. Here, proximity communication device 72 is an LED light bar (see FIG. 4) or the like for confirming the visit to the facility or store of the customer using, for example, visible light communication.

Visitor aggregation unit 17 (acquiring unit) aggregates the number of customers who have viewed the guide information or the like subjected to the push notification among the customers whose visit to the shopping mall or store is confirmed as cumulative information on a behavior of the plurality of customers (users), based on the information (see above) acquired from visitor log collector 21. Visitor aggregation unit 17 may simply aggregate the number of customers whose visit to the shopping mall or shop is confirmed as cumulative information on a behavior of the plurality of customers (users), based on the information (see above) acquired from visitor log collector 21. Visitor aggregation unit 17 stores information on the aggregation results (for example, the number of aggregations, and a user ID corresponding to smartphone 50 or tablet terminal 60 and capable of identifying a customer. The same hereinafter.) in log information management DB 30.

Communication I/F 32 (information notifier) performs various processing for transmission and reception of information or data between portal server 10 and smartphone 50 or portal server 10 and tablet terminal 60 using, for example, a wireless LAN.

Communication I/F 33 (second communicator) performs various processing for transmission and reception of information or data between portal server 10 and proximity communication device 72 using the short range communication (see above).

In addition, portal server 10 includes coupon distribution setting unit 25, coupon distributor 26, coupon reception log collector 27, coupon utilization log collector 28, coupon distribution aggregation unit 22, coupon reception aggregation unit 23, coupon utilization aggregation unit 24, and communication I/Fs 34 and 35.

Coupon distribution setting unit 25 sets various setting items such as functions or contents of coupon distribution to coupon distribution setting screen GM12 (see FIG. 5B) displayed on monitor 41 according to a setting operation of customer company operation manager hm2.

Coupon distributor 26 (information distributor) distributes a coupon to smartphone 50 or tablet terminal 60 carried by each customer through communication I/F 34 according to setting items set by coupon distribution setting unit 25. The coupon is, for example, discount information on commodity or service in the shopping mall and usually has an expiration date. Coupon distributor 26 sends information on smartphone 50 or tablet terminal 60 subjected to the coupon distribution (for example, the number of smartphones or tablet terminals, and a user ID corresponding to smartphone 50 or tablet terminal 60 and capable of identifying a customer. The same hereinafter.) to each of coupon reception log collector 27 and coupon distribution aggregation unit 22, for every coupon distribution.

Coupon distribution aggregation unit 22 (acquiring unit) aggregates the number of smartphones 50 or tablet terminals 60 as an object to be subjected to coupon distribution (that is, the number of smartphones 50 or tablet terminals 60 subjected to the coupon distribution) as cumulative information on a behavior of the plurality of customers (users), based on the information (see above) acquired from coupon distributor 26. Coupon distribution aggregation unit 22 stores information on the aggregation results (for example, the number of aggregations, and a user ID corresponding to smartphone 50 or tablet terminal 60 and capable of identifying a customer. The same hereinafter.) in log information management DB 30.

Coupon reception log collector 27 collects log information indicating that the customer has received the coupon subjected to the coupon distribution (more specifically, acquires the coupon in smartphone 50 or tablet terminal 60) through communication I/F 34. Coupon reception log collector 27 sends the information on the number of smartphones 50 or tablet terminals 60 from which the coupon is acquired in smartphone 50 or tablet terminal 60 which is an object to be subjected to coupon distribution based on the log information and the information acquired from coupon distributor 26, to each of coupon reception aggregation unit 23 and coupon utilization log collector 28. In a case where the coupon subjected to the coupon distribution is received or acquired by an operation of customer, smartphone 50 or tablet terminal 60 sends log information indicating that the coupon subjected to the coupon distribution is received (acquired) to portal server 10.

Coupon reception aggregation unit 23 (acquiring unit) aggregates the number of smartphones 50 or tablet terminals 60 for which the coupon subjected to the coupon distribution is received (acquired) (in other words, the number of views of customer who receives or acquires the coupon subjected to the coupon distribution) as cumulative information on a behavior of the plurality of customers (users), based on the information (see above) acquired from coupon reception log collector 27. Coupon reception aggregation unit 23 stores information on the aggregation results (for example, the number of aggregations, and a user ID corresponding to smartphone 50 or tablet terminal 60 and capable of identifying a customer. The same hereinafter.) in log information management DB 30.

Coupon utilization log aggregation unit 28 collects log information indicating that the coupon which is acquired in smartphone 50 or tablet terminal 60 of the customer has been utilized by proximity communication device 72 through communication I/F 35, for example, at the time of purchase of the commodity or registration of the utilization of service in the store. Coupon utilization log collector 28 sends, for example, information on the number of customers who utilize the coupon at the time of purchase of the commodity or of registration of the utilization of the service in the store to coupon utilization aggregation unit 24 based on the above-described log information. Here, proximity communication device 72 is, for example, a barcode reader or the like which is disposed in the vicinity of a register counter of the store and capable of confirming the utilization of coupon at the time of purchase of the commodity or registration of utilization of the service.

Coupon utilization aggregation unit 24 (acquiring unit) aggregates the number of customers who utilize the coupon at the time of purchase of the commodity or registration of the utilization of the service in the store as cumulative information on a behavior of the plurality of customers (users), based on the information (see above) acquired from coupon utilization log collector 28. Coupon utilization aggregation unit 24 stores information on the aggregation results (for example, the number of aggregations, and a user ID corresponding to smartphone 50 or tablet terminal 60 and capable of identifying a customer. The same hereinafter.) in log information management DB 30.

Communication I/F 34 (information distributor) performs various processing for transmission and reception of information or data between portal server 10 and smartphone 50 or portal server 10 and tablet terminal 60 using, for example, a wireless LAN.

Communication I/F 35 (second communicator) performs various processing for transmission and reception of information or data between portal server 10 and proximity communication device 72 using the short range communication (see above).

In addition, portal server 10 includes touch point selector 11, customer journey screen generator 12, analysis result screen generator 13, display screen generator 14, log information management DB 30, and communication I/F 31.

Touch point selector 11 selects a touch point to be set when the push notification or coupon distribution is performed by customer company operation manager hm2.

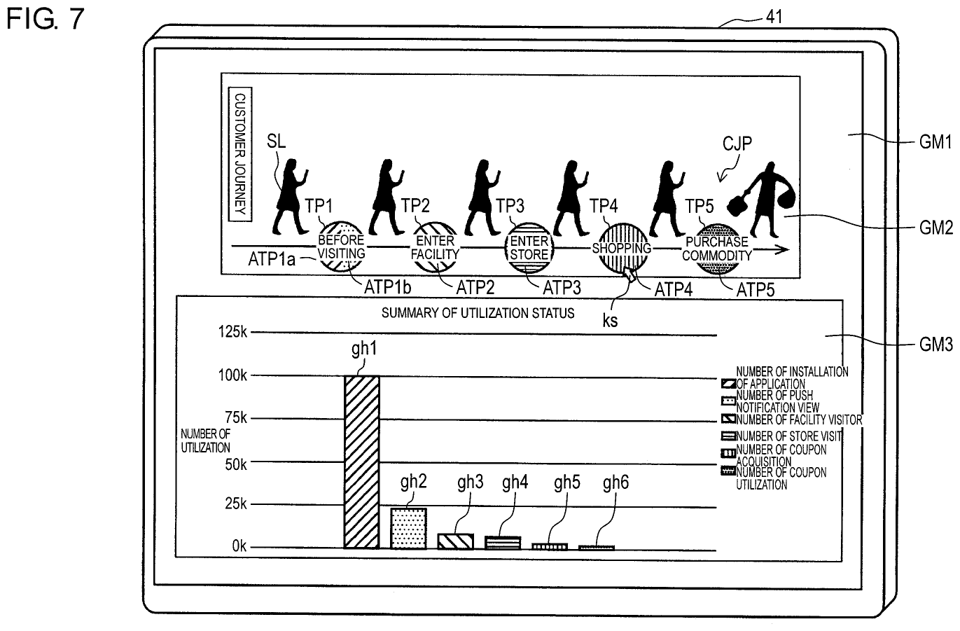

Customer journey screen generator 12 generates customer journey screen GM2 (see FIG. 7) based on display order information (see below) to pass into display screen generator 14.

Analysis result screen generator 13 generates analysis result screen GM3 (see FIG. 7) based on the display order information (see below) and data stored in the log information management DB 30 to pass into display screen generator 14. The display order information is information which is transmitted and received between customer journey screen generator 12 and analysis result screen generator 13 and includes display positional information on each touch point or display layout information on analysis results (for example, a graph and the like described below) corresponding to each touch point.

Display screen generator 14 generates UI screen GM1 (see FIG. 7) including customer journey screen GM2 and analysis result screen GM3 and transmits UI screen GM1 to customer company terminal 40 through communication I/F 31.

Log information management DB 30 registers and manages an aggregation result of number of notifications aggregation unit 15 (for example, the number of push notifications), an aggregation result of number of views aggregation unit 16 (for example, the number of views of contents of push notification), and an aggregation result of visitor aggregation unit 17 (for example, the number of visitors). In addition, log information management DB 30 further registers and manages an aggregation result of coupon distribution aggregation unit 22 (for example, the number of coupon distributions), an aggregation result of coupon reception aggregation unit 23 (for example, the number of coupon acquisitions), and an aggregation result of coupon utilization aggregation unit 24 (for example, the number of coupon utilizations).

Communication I/F 31 (communicator) performs various processing for transmission and reception of information or data between portal server 10 and customer company terminal 40 using, for example, a wired LAN or a wireless LAN. For example, communication I/F 31 transmits UI screen GM1 (see FIG. 7) to monitor 41 so as to display the UI screen.

Customer company terminal 40 has monitor 41 capable of displaying UI screen GM1 which is transmitted from portal server 40 and including customer journey screen GM2 and analysis result screen GM3.

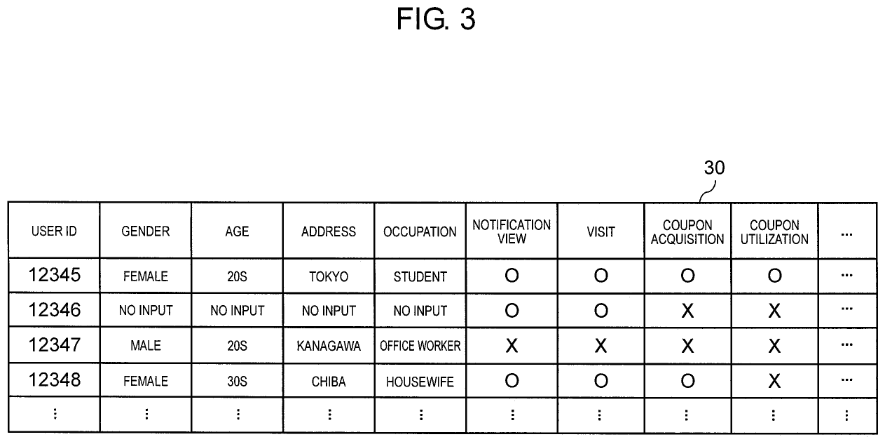

FIG. 3 is a view illustrating an example of registration contents of log information management DB 30. Log information management DB 30 registers information such as gender, an age, an address, an occupation, notification view, visit, coupon acquisition, coupon utilization, or the like associated with each other for each customer's ID (that is, a user ID). For example, gender is “female”, an age is “20s”, an address is “Tokyo”, an occupation is “student”, notification view is “O”, visit is “O”, coupon acquisition is “O”, coupon utilization is “O” and the like are registered to the customer whose user ID is “12345”.

In addition, the setting items of notification view, visit, coupon acquisition, and coupon utilization is denoted by “O” herein, but may be denoted by date-and-time information instead of “O”. The date-and-time information may be date-and-time information acquired by portal server 10 or may be date-and-time information acquired by smartphone 50.

As the date-and-time information acquired by portal server 10, since the date-and-time information using portal server 10 is stored (remains) in portal server 10 as a log, portal server 10 can acquire the date-and-time information from the log. In addition, portal server 10 may acquire the date-and-time information transmitted together with coupon utilization information by the register barcode reader of the register counter in the store as date-and-time information. In addition as the date-and-time information acquired by smartphone 50, smartphone 50 may transmit date-and-time information at the time of utilizing the coupon to portal server 10. This date-and-time information may be information clocked by clock IC built in smartphone 50.

Next, an operation of marketing solution system 5 according to the present embodiment will be described in detail.

FIG. 4 is a view schematically illustrating an example of an operation procedure for providing a service in marketing solution system 5. Here, smartphone 50 will be exemplified and described as a communication terminal carried by the customer. The same is applied to the case where the communication terminal carried by the customer is tablet terminal 60.

User (customer) hm1 downloads and installs, on smartphone 50 carried by the user himself or herself, a touch point application (an example of a dedicated application described above) in advance from an application distribution server (not illustrated) on network NW. The application distribution server may be the same server as portal server 10 or may be another server. The touch point application is an application for which at least one of a service of LinkRay (registered trademark), data transmitted from a beacon terminal, QR code (registered trademark), and the like is available.

In general, the application tends to be installed on the smartphone or tablet terminal immediately after when the application is downloaded. Therefore, the number of downloads and the number of installations in smartphone 50 generally coincide with each other.

For convenience of explanation, FIG. 4 illustrates an example in which the customer purchases a commodity in the store, but the same is applied to the case where the customer purchases a service or registers the utilization thereof.

First, user hm1 operates smartphone 50 to activate the touch point application. When user hm1 comes to a place close to a store facility such as a shopping mall, smartphone 50 receives a visible light signal transmitted from proximity communication device 72 installed at the place (for example, an installation place of bulletin board) (T1). In this case, an LED light bar for performing the visible light communication is used as proximity communication device 72. An optical communication ID is included in a visible light signal transmitted from the LED light bar. The optical communication ID indicates identification information (ID) corresponding to contents posted on the bulletin board provided at a place where proximity communication device 72 is installed.

Smartphone 50 receives the optical communication ID from proximity communication device 72. User hm1 operates a touch panel of smartphone 50 and transmits the optical communication ID to optical communication platform 100 constructed on network NW (T2). Smartphone 50 also transmits the user ID to optical communication platform 100 when transmitting the optical communication ID. Optical communication platform 100 is cooperated with portal server 10 through network NW and sends the user ID received from smartphone 50 to portal server 10 (T3). In addition, optical communication platform 100 receives a uniform resource identifier (URI) for accessing the contents corresponding to the optical communication ID from portal server 10. Optical communication platform 100 may retain the URI corresponding to the optical communication ID in advance without receiving the URI from portal server 10.

Smartphone 50 receives the URI returned from optical communication platform 100 (T4). Smartphone 50 requests contents (accesses contents) specified by URI returned from optical communication platform 100 to portal server 10 (T5). Smartphone 50 also transmits the user ID to portal server 10 at the time of accessing the contents.

When the coupon stored in smartphone 50 is read by the register barcode reader of the register counter in the store, the barcode reader or register is connected to portal server 10 through the network. In this case, the user ID of smartphone 50 which is read by the barcode reader is transmitted to portal server 10.

When the URI is received from smartphone 50, portal server 10 returns the contents requested and specified by the URI to smartphone 50 (T6). In addition, portal server 10 performs the push notification such as guide information on commodity or service to smartphone 50 of the user according to setting of push notification setting screen GM11 (see FIG. 5A) (T7). When the push notification is performed, notice information such as guide information on commodity or service is displayed on the touch panel of smartphone 50.

In addition, when the contents are transmitted to smartphone 50, portal server 10 records this access log in log information management DB 30 (T8). Accordingly, registration contents of log information management DB 30 is always updated according to utilization results of portal server 10.

On the other hand, customer company terminal 40 operated by customer company operation manager hm2 registers and manages smartphone contents in portal server 10 (T11).

In addition, customer company terminal 40 registers and manages the URI of smartphone contents in portal server 10 (T12). In the registration management of the URI of the contents, customer company terminal 40 sets various setting items related to the coupon distribution on coupon distribution setting screen GM12 (see FIG. 5B). Customer company terminal 40 sets various setting items on coupon distribution setting screen GM12 of portal server 10, thereby performing the coupon distribution. Portal server 10 generates a content screen including the coupon according to the setting of various setting items on coupon distribution setting screen GM12 and stores the content screen so as to be viewable. A viewer of the touch point application of smartphone 50 of user hm1 displays the content screen including the coupon stored in portal server 10. The coupon distribution is not limited to this method, and may be performed by portal server 10 which actually transmitting an email with a coupon to smartphone 50.

In addition, customer company terminal 40 registers and manages push distribution in portal server 10 (T13). Customer company terminal 40 sets various setting items related to the push notification on push notification setting screen GM11 (see FIG. 5A) through the registration management of the push distribution. In the push notification, the guide information on commodity or service or the like is distributed. Note that, the push notification may be a geo-push notification.

In addition, customer company terminal 40 analyzes a utilization effect of the marketing solution service (T14). Customer company terminal 40 displays analysis result screens GM13 and GM14 (see FIGS. 5C and 5D) on monitor 41 based on the log information managed by portal server 10, through the analysis of the utilization effect.

FIG. 5A is a view illustrating push notification setting screen GM11 displayed on monitor 41. Items such as the number of push notifications (for example, “29”), a comment (for example, “send the message to the application with notification turned on”), notification information (for example, including a title input field, a message input field, and an image input field), and the like are displayed on push notification setting screen GM11. The number of push notifications indicates the number of smartphones 50 or tablet terminals 60 on which the guide information on commodity or service or the like is subjected to the push notification. The notification information (for example, a title input field, a message input field, and an image input field) is appropriately set by inputting an operation of customer company operation manager hm2.

FIG. 5B is a view illustrating coupon distribution setting screen GM12 displayed on monitor 41. Items such as a discount rate and a valid period of the registered coupon, various setting items related to a newly issued coupon (for example, registration of new coupon, an upload field, an input field (including a valid period, precautions, the number of utilizations, and a presentation condition)) are displayed on coupon distribution setting screen GM12. Various setting items related to a newly issued coupon (for example, registration of new coupon, an upload field, an input field (including a valid period, precautions, the number of utilizations, and a presentation condition)) are appropriately set by inputting the operation of customer company operation manager hm2.

FIG. 5C is a view illustrating analysis result screen GM13 displayed on monitor 41. A graph representing the number of downloads of the touch point application in the time series is displayed on analysis result screen GM13. As described above, the number of downloads and the number of installations in smartphone 50 are considered equal. “This Month 214” is displayed in FIG. 5C and it can be seen that 214 people install the touch point application in this month. In addition, a graph showing the number of installations per day is displayed.

FIG. 5D is a view illustrating analysis result screen GM14 displayed on monitor 41. A graph showing the number of downloads of the touch point application per day, the number of coupon distributions, and the number of news views is displayed on analysis result screen GM14. In FIG. 5D, the number of coupon distributions indicates the number of smartphones 50 or tablet terminals 60 subjected to the coupon distribution. Similarly, the number of news views indicates the number of smartphones 50 or tablet terminals 60 on which the guide information on commodity or service (including news information) is subjected to the push notification.

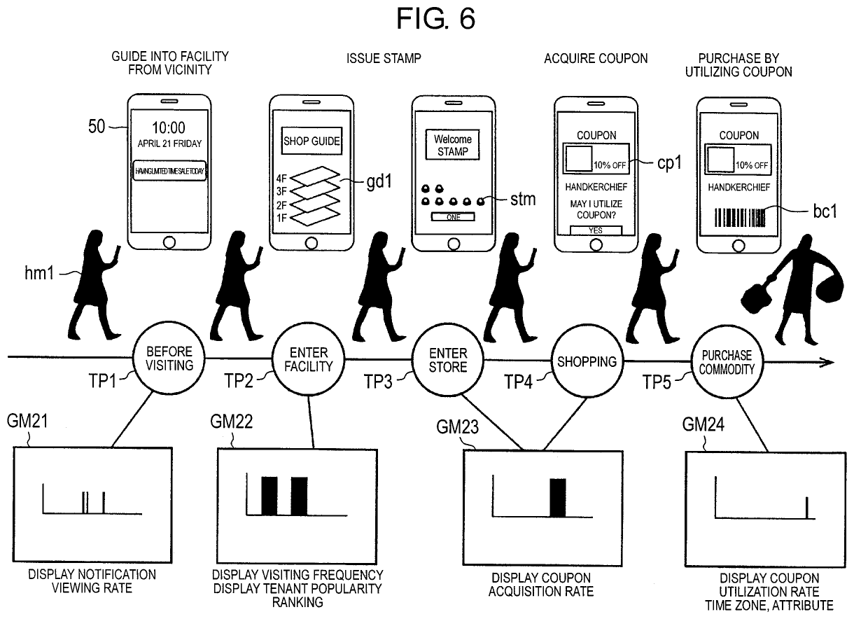

FIG. 6 is a view illustrating an example of an overview of marketing solution system 5. In marketing solution system 5, portal server 10 performs the push notification such as guide information on commodity or service or geo-push communication on smartphone 50 carried by user hm1 at touch point TP1 corresponding to a point in time before user (customer) hm1 visits the shopping mall (before visiting). Portal server 10 performs the push notification such as guide information, thereby guiding the user in the vicinity of a commercial facility such as a shopping mall into the commercial facility. Examples of the guide information include a time sale of commodity or service. When user hm1 views the guide information, smartphone 50 transmits the log information viewed by user hm1 to portal server 10. At touch point TP1 corresponding to the point in time before visiting the store, portal server 10 analyzes a view status of the guide information and generates analysis result screen GM21 including a guide viewing rate (notification viewing rate) to display the analysis result screen on monitor 41.

When user hm1 enters the commercial facility such as a shopping mall, proximity communication device 72 (for example, an LED light bar) installed at the entrance of the commercial facility performs visible light communication with smartphone 50 and acquires the user ID of smartphone 50 to confirm the visit of the user, at touch point TP2 corresponding to a point in time when entering the commercial facility. The user ID of smartphone 50 acquired by proximity communication device 72 is sent to portal server 10 through optical communication platform 100. Proximity communication device 72 transmits facility guidance gd1 to smartphone 50. Facility guidance gd1 is displayed on the touch panel of smartphone 50. Portal server 10 counts the number of people who enters the commercial facility, generates analysis result screen GM22 including a visiting frequency and a tenant popularity ranking to display the analysis result screen on monitor 41 at touch point TP2 corresponding to the point in time when entering the commercial facility.

When user hm1 enters the store in the commercial facility such as a shopping mall, proximity communication device 72 (for example, an LED light bar) installed at the entrance of the store performs optical communication with smartphone 50 and acquires the user ID of smartphone 50 to confirm the entry of the store, at touch point TP3 corresponding to a point in time when entering the store. The user ID of smartphone 50 acquired by proximity communication device 72 is sent to portal server 10 through optical communication platform 100. In addition, proximity communication device 72 transmits stamp stm issued by optical communication platform 100 to smartphone 50. Smartphone 50 collects the received stamp stm. Stamp stm collected in smartphone 50 is displayed on the touch panel of smartphone 50 so as to be used as, for example, a discount rate at the time of purchasing a commodity or the like.

When user hm1 performs a behavior of stopping and looking at the commodity put on a display shelf in the store (which is referred to as a “stationary behavior”), that is, starts shopping, proximity communication device 72 installed on the display shelf or the like performs the visible light communication with smartphone 50 at touch point TP4 corresponding to the point in time when shopping and acquires the user ID of smartphone 50 to confirm the shopping. The user ID of smartphone 50 acquired by proximity communication device 72 is sent to portal server 10 through optical communication platform 100. Proximity communication device 72 distributes coupon cp1 issued by portal server 10 to smartphone 50 through optical communication platform 100. Smartphone 50 stores the acquired coupon cp1. Coupon cp1 stored in smartphone 50 can be used as, for example, a discount rate at the time of purchasing a commodity or the like. Portal server 10 analyzes a behavior and preference of the user at touch point TP3 corresponding to the point in time when entering the store and touch point TP4 corresponding to the point in time when shopping, and generates analysis result screen GM23 including a coupon acquisition rate to display the analysis result screen on monitor 41.

When user hm1 purchases the commodity using coupon cp1, the register barcode reader of the register counter reads barcode bc1 of the commodity at touch point TP5 corresponding to a point in time when purchasing the commodity, and settlement processing is performed. In the settlement processing, information including purchase information on commodity (a price, whether or not the coupon is utilized, and the like) and the user ID is transmitted to portal server 10. Portal server 10 analyzes coupon utilization rate measurement and a purchase status at touch point TP5 corresponding to the point in time when purchasing the commodity and generates analysis result screen GM24 including a coupon utilization rate and a purchase status for time zone or attribute to display the analysis result screen on monitor 41.

FIG. 7 is a view illustrating UI screen GM1 displayed on monitor 41 of customer company terminal 40. Customer journey screen GM2 and analysis result screen GM3 are displayed on UI screen GM1 in a contrast manner, customer journey screen GM2 showing a plurality of behaviors in the time series until the customer purchases the commodity or service, and analysis result screen GM3 showing an analysis result of the behavior of the customer at a touch point corresponding to a point in time when respective behaviors occur.

Customer journey map CJP is drawn on customer journey screen GM2. As customer journey map CJP, areas ATP1a and ATP1b of touch point TP1 corresponding to the point in time before visiting the store, area ATP2 of touch point TP2 corresponding to the point in time when entering the facility, area ATP3 of touch point TP3 corresponding to the point in time when entering the store, area ATP4 of touch point TP4 corresponding to the point in time when shopping, and area ATP5 of touch point TP5 corresponding to the point in time when purchasing the commodity are respectively drawn. Areas ATP1a and ATP1b to ATP5 are drawn as marks of touch points TP1 to TP5, respectively. In addition, touch point TP1 corresponding to the point in time before visiting the store includes a touch point corresponding to a point in time when a behavior of which the customer installs the touch point application occurs and a touch point corresponding to a point in time when a behavior of which the customer views the guide information or the like subjected to the push notification occurs.

When any one of areas ATP1 to ATP5 is selected by cursor ks by an operation of customer company operation manager hm2, portal server 10 shifts the touch point corresponding to the selected area to a detailed display screen. For example, it is assumed that area ATP4 of touch point TP4 corresponding to the point in time when shopping is selected. In this case, portal server 10 shifts and displays area ATP4 from UI screen GM1 displayed on monitor 41 to coupon distribution setting screen GM12 (see FIG. 5B) as the detailed display screen. In a case where the area of the touch point is selected, function setting screens (a push notification setting screen and a coupon distribution setting screen) for setting a function of the touch point of the selected area and a detailed information screen including detailed information on the touch point may be displayed on monitor 41 as a separate screen.

Thus, customer company operation manager hm2 can directly (that is, without switching the screen) switch from analysis result screen GM3 to push notification setting screen GM11 (see FIG. 5A) or coupon distribution setting screen GM12 (see FIG. 5B), to thereby enhance work efficiency in analysis and setting.

In addition, on UI screen GM1, silhouette SL representing the user's behavior is drawn at each of touch points TP1 to TP5. Here, silhouette SL at touch points TP1 to TP4 represents an appearance of the user who is looking at the smartphone while walking, and silhouette SL at touch point TP5 represents an appearance of the user who happily purchases the commodity. In addition, silhouette SL at touch points TP1 to TP4 may represent a different appearance of the user (for example, user who is wondering whether to purchase the commodity with his/her head tilted, or the like).

On the other hand, on analysis result screen GM3, a graph showing the number of utilizations of behaviors and the number of performers (hereinafter, referred to as “the number of utilizations”) at each of touch points TP1 to TP5 is drawn as a summary of utilization status (an example of analysis result). A vertical axis of the graph represents the number of utilizations, and a horizontal axis of the graph represents an event performed at touch points TP1 to TP5 in the time series.

Bar graph gh1 represents the number of installations of touch point application (that is, the number of installations of application) as one of a plurality of events composing touch point TP1 corresponding to the point in time before visiting the store.

Bar graph gh2 represents the number of push notification views (that is, the number of views such as guide information subjected to the push notification) as one of the plurality of events composing touch point TP1 corresponding to the point in time before visiting the store.

Bar graph gh3 represents the number of visits to the commercial facility (the number of facility visitors) such as a shopping mall at touch point TP2 corresponding to the point in time when entering the facility.

Bar graph gh4 represents the number of store visits at touch point TP3 corresponding to the point in time when entering the store.

Bar graph gh5 represents the number of coupon acquisitions at touch point TP4 corresponding to the point in time when shopping.

Bar graph gh6 represents the number of coupon utilizations at touch point TP5 corresponding to the point in time when purchasing the commodity.

In the vicinity of the top of bar graphs gh1 to gh6, numerical values of the number of utilizations and utilization rate may be displayed, and the accurate value of the bar graphs can be presented.

On UI screen GM1, display forms of touch points TP1 to TP5 (or events composing the touch point) and bar graphs gh1 to gh6 are aligned to be corresponded to each other. For example, area ATP1a installed at touch point TP1 corresponding to the point in time before visiting the store and bar graph gh1 are displayed in blue (right hatching in FIG. 7) in the same manner. Area ATP1b subjected to the push notification at touch point TP1 corresponding to the point in time before visiting the store and bar graph gh2 are displayed in yellow (sparse dots in FIG. 7) in the same manner.

Area ATP2 of touch point TP2 corresponding to the point in time when entering the facility and bar graph gh3 are displayed in green (left hatching in FIG. 7) in the same manner.

Area ATP3 of touch point TP3 corresponding to the point in time when entering the store and bar graph gh4 are displayed in orange (horizontal straight line in FIG. 7) in the same manner.

Area ATP4 of touch point TP4 corresponding to the point in time when shopping and bar graph gh5 are displayed in violet (vertical straight line in FIG. 7) in the same manner.

Area ATP5 of touch point TP5 corresponding to the point in time when purchasing the product and bar graph gh6 are displayed in pink (dense dots in FIG. 7) in the same manner.

A layout on the screen of areas ATP1a and ATP1b to ATP5 of touch points TP1 to TP5 and bar graphs gh1 to gh6 is determined based on display order information exchanged between customer journey screen generator 12 and analysis result screen generator 13.

As such, by associating the areas of touch points TP1 to TP5 and bar graphs gh1 to gh6 with a display color, a corresponding relationship between each of the touch points of customer journey and the graphs are easily visually understood for customer company operation manager hm2. Accordingly, measures can be effectively improved based on the analysis results reflected in the bar graphs. As a display form for associating the areas of touch points and the bar graphs, it may be divided into a shape such as hatching, dots, or painting in addition to the display color, or line types such as a thickness, a dotted line, a solid line, and an alternate long and short dash line.

In marketing solution system 5 according to the present embodiment, portal server 10 is connected to be communicable with smartphone 50 carried by each of the plurality of users. In a case where the plurality of users perform, in the time series, a plurality of behaviors until the plurality of users purchase the commodity or service in the shopping mall (actual facility) or on an online shopping website (virtual facility) or register the utilization thereof, portal server 10 acquires information on the behavior of the plurality of users for each of touch points TP1 to TP5 corresponding to a point in time when at least some of the plurality of behaviors occurs. For example, portal server 10 acquires at least one of the number of push notification viewers, the number of visitors, the number of coupon receivers, and the number of coupon users. Further, portal server 10 outputs and transmits the number of push notification viewers, the number of visitors, the number of coupon receivers, and the number of coupon users at each of the touch points TP1 to TP5 to monitor 41 so as to display them along the time series.

As described above, portal server 10 can visually show the analysis result of at least a part of the process such as a time-series behavior of which the plurality of customers purchase or register the commodity or service and enhance the convenience for analysis of the process such as behaviors of the plurality of customers. In addition, portal server 10 can simultaneously display, on monitor 41, customer journey screen GM2 including customer journey map CJP and analysis result screen GM3 including bar graphs gh1 to gh5 indicating the number of utilizations of touch points TP1 to TP5 on customer journey map CJP. Accordingly, customer company operation manager hm2 can intuitively and visually confirm a result (an effect) of measures for each behavior performed until the plurality of users purchase the commodity or service or register the utilization thereof in the time series. In addition, customer company operation manager hm2 can easily consider an improvement of measures (for example, increase a discount rate for a store at a certain time) with respect to the behavior of the customer.

Portal server 10 acquires the number of the plurality of users who visit the actual store, as information on a behavior of the plurality of users in association with touch point TP3 corresponding to the point in time when a behavior of which the plurality of users visit the actual store in the shopping mall (in actual facility) occurs. Thus, customer company operation manager hm2 can easily analyze the number of the plurality of users who visit the store in the shopping mall, or the like, which can lead to the improvement of measures such as customer attraction.

Portal server 10 is installed in, for example, the actual store (store in the shopping mall), and communicates with proximity communication device 72 (an example of an information communication device) which performs short range communication with smartphone 50 or tablet terminal 60. The proximity communication device 72 performs the short range communication (for example, visible light communication) with smartphone 50 in the store, such that portal server 10 determines the behavior of the plurality of customers visiting the actual store based on the result of the short range communication and acquires the number of the plurality of customers who visit the actual store.

Thus, portal server 10 can confirm actual visit of the customer and enhance accuracy in a behavior of customer who visits the store. Portal server 10 may determine the behavior of visiting the store by receiving the content access of the URI from smartphone 50 based on an optical communication ID obtained by the visible light communication, and may determine the behavior of visiting the store based on the purchase information read by the register barcode reader connected to network NW.

Portal server 10 acquires identification information (for example, a user ID) of smartphone 50 transmitted from smartphone 50 by the short range communication (for example, visible light communication) through proximity communication device 72 to identify smartphone 50. Thus, portal server 10 can smoothly perform the push notification such as guide information or the coupon distribution such as discount information in compliance with a user who carries a communication terminal such as smartphone 50 or tablet terminal 60, and appropriately carry out the measures necessary to attract customers and increase sales.

Portal server 10 acquires information (specifically, the number of installations of touch point application, the number of push notification views, the number of facility visitors, the number of store visits, the number of coupon acquisitions, and the number of coupon utilizations) of the number of users who performs the behavior corresponding to each of the touch points, as information on the behavior of the plurality of users. Thus, at the touch point, portal server 10 accurately grasps the number of users who actively performs the behavior until the customer purchases the commodity or service and registers the utilizations thereof in the time series.

Portal server 10 can notify (perform the push notification) smartphone 50 or terminal tablet 60 of the at least the guide information on the commodity or service. Portal server 10 acquires the number of smartphones 50 or tablet terminals 60 subjected to the push notification as information on the behavior of the plurality of users in association with the touch point corresponding to a point in time when notification processing such as guide information before visiting the actual store occurs. Thus, customer company operation manager hm2 can easily attract customers who have not yet visited the actual store.

Portal server 10 acquires the number of smartphones 50 or tablet terminals 60 subjected to the push notification as information on the behavior of the plurality of users in association with a touch point corresponding to a point in time when the notification processing such as guide information during visiting the actual store occurs. Thus, customer company operation manager hm2 can analyze the effect by distributing the guide information on a commodity or service to the customer who is visiting the store, and for example, can easily lead to attracting the customers such as guiding the customers to other stores.

Portal server 10 acquires the number of smartphones 50 or tablet terminals 60, for which utilization processing of discount information (coupon) of the commodity or service is determined based on a purchase behavior or a registration behavior, as information on a behavior of the plurality of users in association with the touch point corresponding to a point in time when the behavior of purchasing or registering the commodity or service during visiting the actual store occurs. Thus, customer company operation manager hm2 can analyze the detail of the purchase behavior or registration behavior of the user who is visiting the store, for example, can analyze how much discount is effective in the purchase behavior or registration behavior and effectively supports sales promotion activities in the store.

Portal server 10 further acquires the number of smartphones 50 or tablet terminals 60, for which communication processing (for example, see procedure T1 in FIG. 4) is determined based on a stationary behavior for the commodity or service, as information on a behavior of the plurality of users in association with the touch point corresponding to a point in time when the stationary behavior for the commodity or service during visiting the actual store occurs. Thus, customer company operation manager hm2 can analyze an effect of (the stationary behavior) the behavior of the customer who stops and looks at the commodity or the like displayed in the store and can further promote the purchase behavior.

Portal server 10 acquires the number of the plurality of users who visit the actual store or the number of accesses to the virtual store as information on the behavior of the plurality of users, in association with the touch point corresponding to a point in time when a behavior of the plurality of users who visit the actual store as the actual facility (each store in the shopping mall) or a behavior of the customer who accesses the virtual facility (the online shopping website) occurs. Thus, portal server 10 can perform the push notification of the suitable and useful guide information on smartphone 50 or tablet terminal 60 carried by each customer in compliance with the number of the plurality of customers who visit the actual commercial facility or the number of accesses to the virtual facility.

Portal server 10 can distribute (perform coupon distribution) discount information of at least the commodity or service to smartphone 50 or tablet terminal 60. At the touch point corresponding to the point in time before visiting the actual store, portal server 10 either performs the coupon distribution to smartphone 50 or tablet terminal 60 or acquires the identification information on smartphone 50 or tablet terminal 60 as an object to be subjected to the coupon distribution. Thus, portal server 10 substantially distributes the coupon to smartphone 50 or tablet terminal 60 of the customer who has not yet visited the store, which can easily attract the customers, who have not yet visited the store, to the actual store.

Portal server 10 acquires, from proximity communication device 72, information on smartphone 50 or tablet terminal 60 (for example, identification information) which communicates with proximity communication device 72 using at least one of near field communication, reading two-dimensional barcode, and visible light communication as short range communication. Thus, portal server 10 can easily grasp and aggregate the presence or absence of the customer near proximity communication device 72 through proximity communication device 72 by means of various methods.

In the related art, it could not be seen that the push notification setting screen and an effect obtained by the push notification (for example, the number of customers who visit the store) were not shown in conjunction with each other. Similarly, the coupon distribution setting screen and an effect obtained by the coupon distribution (for example, sales of a coupon object commodity) were not shown in conjunction with each other. Therefore, in order to confirm the effects obtained by the measures when various setting screens related to the push notification and the coupon distribution are displayed to perform the respective settings, the customer company operation manager needed to operate each screen to show their effects separately. In other words, convenience at the time of input operation of customer company operation manager has deteriorated when performing setting related to various measures such as push notification or coupon distribution.

However, portal server 10 according to the present embodiment transmits, to monitor 41, so as to display information setting screen related to the behavior of the user corresponding to any one touch point corresponding to selected areas ATP1a to ATP5, according to a selecting operation (for example, the area of the touch point is considered as a button) of area (specifically, any one of areas ATP1a to ATP5) of any one of touch points TP1 to TP5 each displayed on monitor 41. For example, portal server 10 displays push notification setting screen GM11 or coupon distribution setting screen GM12 on monitor 41, and functions to be set according to push notification setting screen GM11 or coupon distribution setting screen GM12. Thus, customer company operation manager hm2 can visually and easily perform setting of the touch point based on information on the behavior of the user at the touch point, and thus operability is improved. Customer company operation manager hm2 can directly (that is, without switching the screen) switch from analysis result screen GM3 to push notification setting screen GM11 (see FIG. 5A) or coupon distribution setting screen GM12 (see FIG. 5B), to thereby enhance work efficiency in analysis and setting. Further, it can be easily grasped that the area can be selected in the selection operation by designing the area like a button. The design of area may be stereoscopically displayed (shaded, or the like) and a part of area (for example, an outer frame portion of area) may be flickered so as to be identified more conspicuously than other parts in the same screen.

### ANOTHER DISPLAY EXAMPLE 1

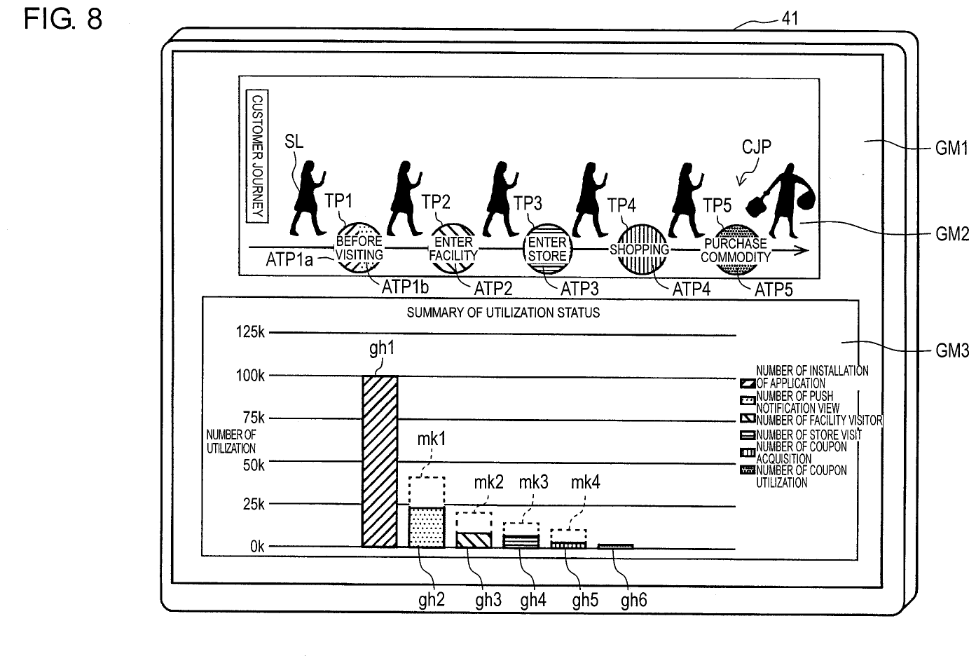

FIG. 8 is a view illustrating another UI screen GM1 displayed on monitor 41 of customer company terminal 40. When the number of utilizations of each of touch points TP1 to TP5 does not reaches a key performance indicator (KPI), the number of insufficient utilizations to reach the KPI, that is, rectangular marks mk1 to mk4 indicating difference between the KPI and actual results, are drawn on UI screen GM1. Rectangular marks mk1 to mk4 respectively indicates the number of insufficient utilizations in the number of push notification views, the number of facility visitors, the number of store visits, and the number of coupon acquisitions.

Since the number of installations of touch point application and the number of coupon utilizations exceeds the KPI, the rectangular mark indicating the remaining number of utilizations are not drawn. Not only the rectangular mark is simply drawn, but also the KPI value or an achievement ratio may be appended to the vicinity of the rectangular mark (for example, an upper side).

As such, rectangular marks mk1 to mk4 indicating the remaining number of utilizations until the KPI reaches are drawn, such that the difference between the KPI and the actual result can be visually confirmed. Accordingly, the customer company operation manager can visually grasp the measures at the touch point in which the number of utilizations does not reach the KPI. Thus, portal server 10 allows the customer company operation manager to encourage the improvement of measures so as to achieve the KPI. In particular, the customer company operation manager can take a countermeasure, such as, considering, with a high priority, how to improve measures having the large difference between the KPI and the actual result. In addition, as the improvement of measures is encouraged, an increase in sales can be expected.

### ANOTHER DISPLAY EXAMPLE 2

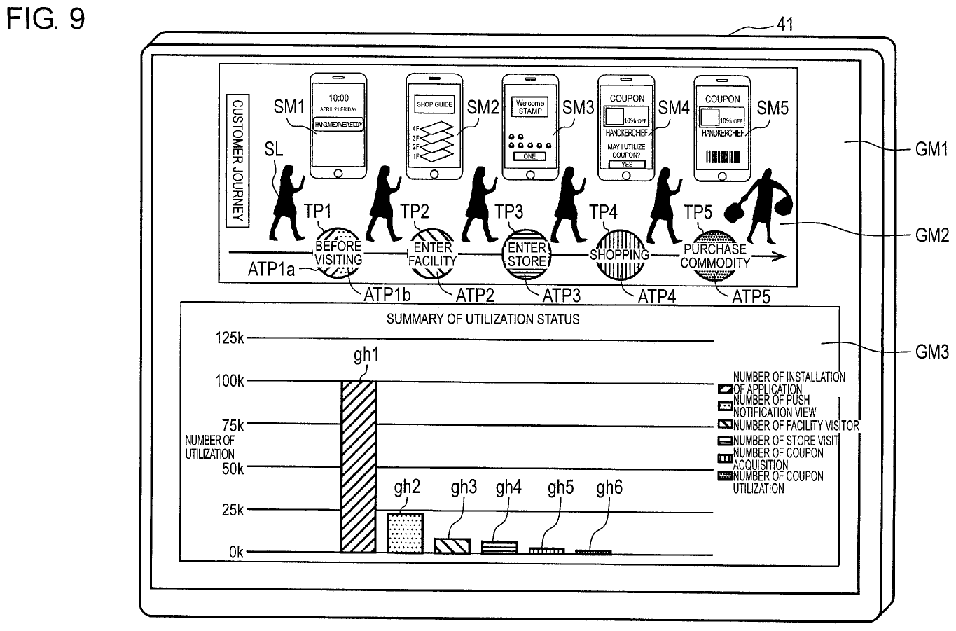

FIG. 9 is a view illustrating another UI screen GM1 displayed on monitor 41 of customer company terminal 40. Each of touch points TP1 to TP5 in addition to customer journey map CJP is displayed on customer journey screen GM2, and the screen displayed on the touch panel of smartphone 50 is displayed together with the customer journey screen on UI screen GM1.

Home screen SM1 is displayed on the touch panel of smartphone 50 at touch point TP1 before visiting the store. Shop guide screen SM2 for introducing the stores on each floor in the facility is displayed on the touch panel of smartphone 50 as facility guidance gd1 at touch point TP2 of entering the facility. Stamp management screen SM3 is displayed at touch point TP3 of entering the store. Coupon acquisition screen SM4 is displayed at touch point TP4 of shopping. Coupon utilization screen SM5 is displayed at touch point TP5 of purchasing the commodity. When home screen SM1, shopping guide screen SM2, stamp management screen SM3, coupon acquisition screen SM4, and coupon utilization screen SM5 are each generated on the touch point application installed on smartphone 50 or tablet terminal 60, the generated home screen SM1, shopping guide screen SM2, stamp management screen SM3, coupon acquisition screen SM4, and coupon utilization screen SM5 are transmitted from smartphone 50 or tablet terminal 60, received and acquired in portal server 10. In addition, home screen SM1, shopping guide screen SM2, stamp management screen SM3, coupon acquisition screen SM4, and coupon utilization screen SM5 may be generated in portal server 10 (for example, display screen generator 14).

As such, the touch panel screen of smartphone 50 which corresponds to touch points TP1 to TP5 is displayed on UI screen GM1. Accordingly, a company operation manager can achieve the improvement of measures based on the touch panel screen of smartphone 50 in addition to touch points TP1 to TP5 on customer journey map CJP and the summary of utilization status of analysis result screen GM3.

### ANOTHER DISPLAY EXAMPLE 3

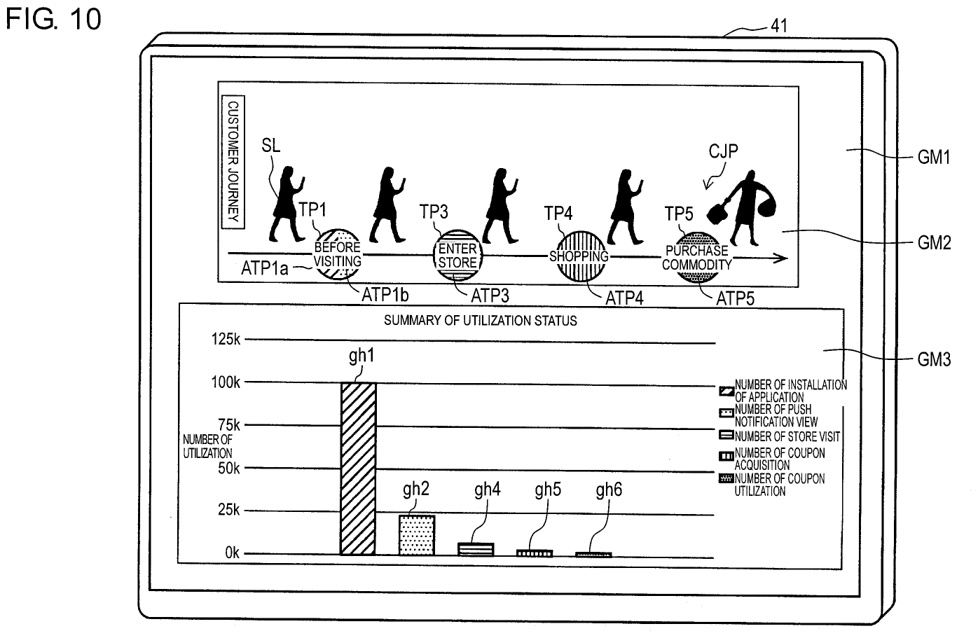

FIG. 10 is a view illustrating another UI screen GM1 displayed on monitor 41 of customer company terminal 40. For example, in a case where the behavior of the customer who visits the store such as a retail store is considered rather than a large-sized facility (a tenant in the facility) such as a shopping mall, the touch point of entering the facility may be omitted. In UI screen GM1, the touch point of entering the facility is omitted in customer journey screen.

As such, more simple UI screen can be presented to a retail store or the like which is not in the commercial facility. In addition, processing loads of portal server 10 can be reduced. In addition, the customer company operation manager can easily analyze a process such as a behavior of the plurality of customers.

### ANOTHER DISPLAY EXAMPLE 4

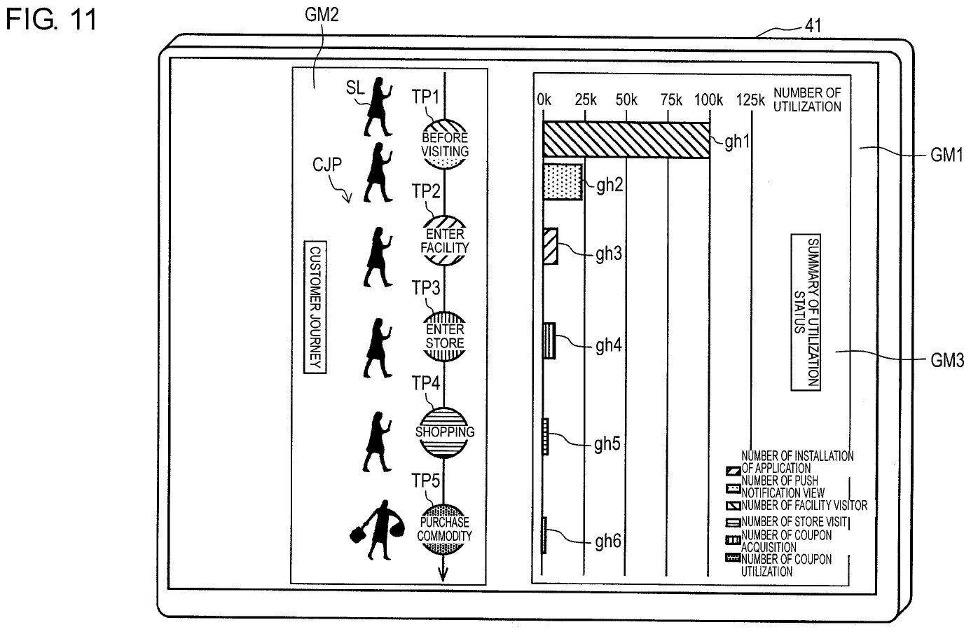

FIG. 11 is a view illustrating another UI screen GM1 displayed on monitor 41 of customer company terminal 40. In UI screen GM1, customer journey screen GM2 and analysis result screen GM3 are arranged in a row direction along the time series showing elapse of time downward in a vertical direction. Thus, UI screen GM1 can be displayed according to preference of the user, and the customer company operation manager can easily see UI screen GM1.

### ANOTHER DISPLAY EXAMPLE 5

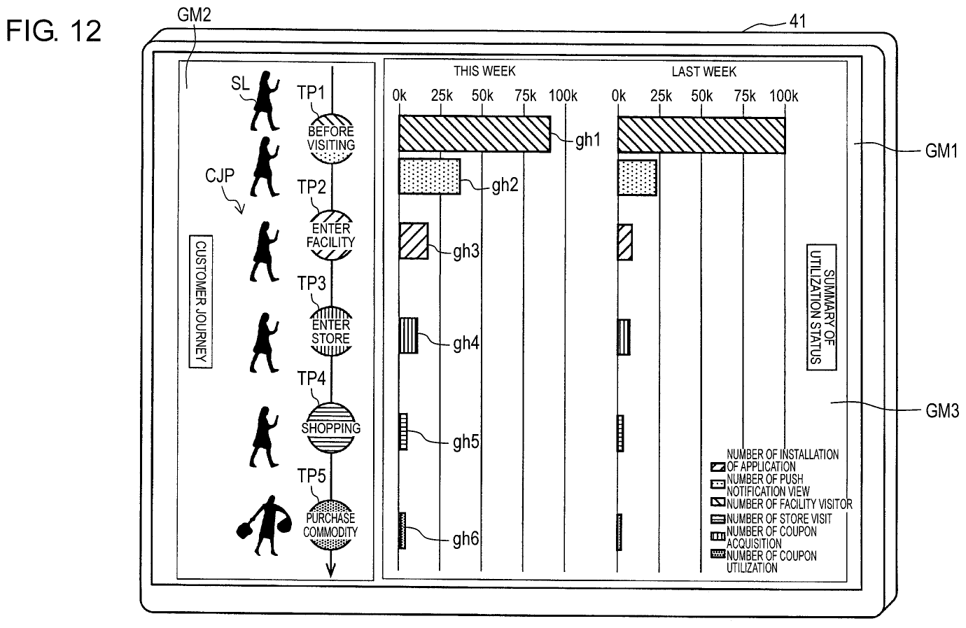

FIG. 12 is a view illustrating another UI screen GM1 displayed on monitor 41 of customer company terminal 40. As compared with FIG. 11, analysis result screen GM3 can further be divided for each period and displayed on UI screen GM1. In FIG. 12, a graph showing the number of utilizations at each of touch points TP1 to TP5 is drawn as a summary of utilization status on a weekly basis.

As such, the analysis result can be seen by being compared for a predetermined period, and the customer company operation manager can evaluate the improvement result of measures for a predetermined period (on a weekly basis).

### Second Embodiment

In the first embodiment, customer journey screen GM2 and analysis result screen GM3 were displayed, with all of the installation of touch point application, the push notification view, the facility visit, the store visit, the coupon acquisition, and the coupon utilization as touch points. In a second embodiment, customer journey screen GM2 and analysis result screen GM3 are displayed with the installation of touch point application, the push notification view, the facility visit, and the store visit in order to attract the customer as touch points.

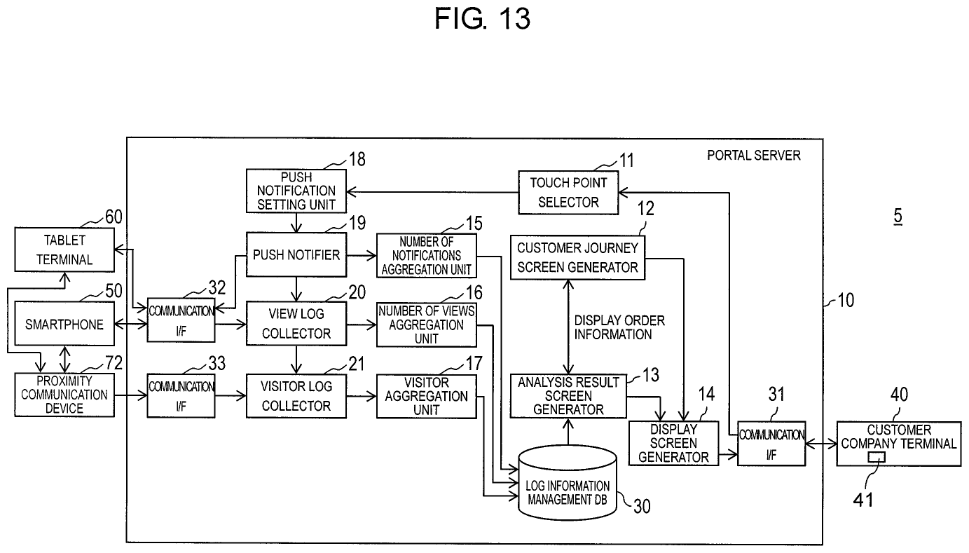

FIG. 13 is a block diagram illustrating an example of a detailed internal configuration of portal server 10 according to the second embodiment. In portal server 10 of the second embodiment, the same components as those of portal server 10 of the first embodiment are denoted by the same reference numerals, and the description thereof will be omitted.

Portal server 10 grasps the push notification, the push notification view, and the store visit as touch points, and does not use the coupon distribution and coupon utilization as touch points. Accordingly, for example, the portal server 10 can utilize the touch points for analyzing the customer attraction to an event site without purchasing the commodity or service.

### Third embodiment

In a third embodiment, customer journey screen GM2 and analysis result screen GM3 are displayed with the coupon acquisition and the coupon utilization as touch points, in order to promote the purchase behavior of user.

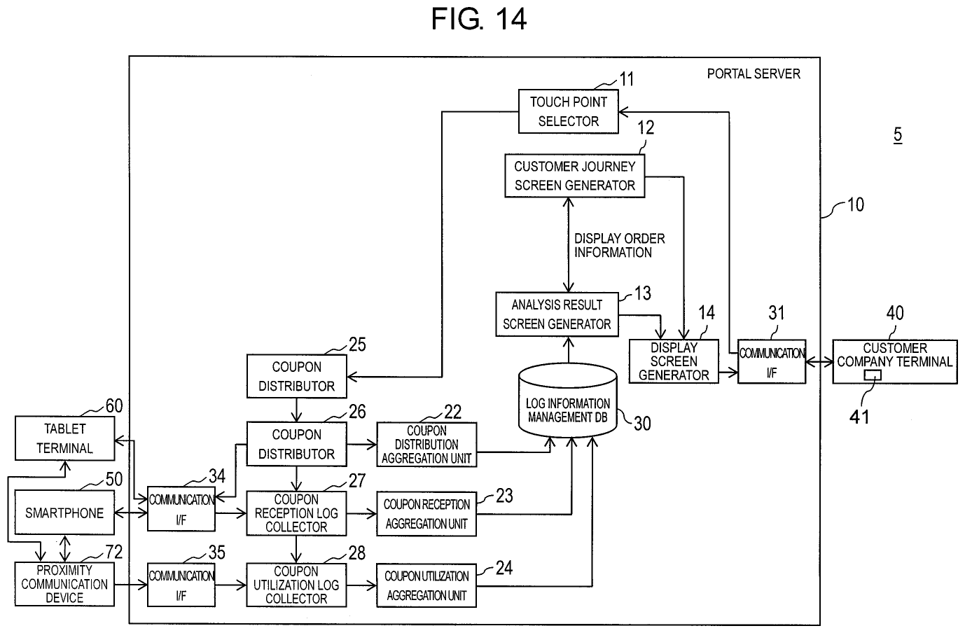

FIG. 14 is a block diagram illustrating an example of a detailed internal configuration of portal server 10 according to the third embodiment. In portal server 10 of the third embodiment, the same components as those of portal server 10 of the first embodiment are denoted by the same reference numerals, and the description thereof will be omitted.

Portal server 10 grasps the coupon distribution and the coupon utilization as touch points, and does not use the push notification, the push notification view, and the visit the store as touch points. Accordingly, for example, the portal server can utilize the touch points for analyzing the purchase of commodity or service without performing the customer attraction to the store.

Although various embodiments have been described with reference to the drawings hereinabove, it goes without saying that the present disclosure is not limited to such examples. It is obvious that a person skilled in the art could conceive of various types of altered examples or modified examples within the categories described in the claims, and naturally it is to be understood that these also belong to the technical scope of the present disclosure. Furthermore, the components in the aforementioned embodiments may be arbitrarily combined without deviating from the purpose of the disclosure.

For example, in the above embodiments, the customer journey shows a time-series pattern of performing the coupon distribution after the push notification, but the time-series pattern is not limited to the pattern. For example, the customer journey may be a time⁻series pattern in which the coupon is suddenly distributed to attract the customer and increase sales without performing the push notification. In addition, the customer journey may be a time-series pattern in which the push notification is performed to encourage to visit the store.

As described above, the time series of various touch point displayed on the UI screen as shown in FIG. 7, and the like, for example, is a time series of the touch point of distributing the coupon when entering the facility and performing the push notification of different commodity information after purchasing the commodity, or the like, as an example.

In the above embodiments, the behavior (customer behavior) of customer who leads to purchasing the commodity at the actual store is simultaneously displayed with the analysis result, but similarly, the customer behavior may be simultaneously displayed with the analysis result when purchasing the commodity at the online store on the network.

In the above embodiment, the installation of touch point application is performed before visiting the store. It is not limited to the timing, and the user may read a QR code (registered trademark) present at, for example, the facility or store, after visiting the facility or store by a smartphone (communication terminal), access the server, and download and install the touch point application.

For example, a plurality of LED light bars for performing the visible light communication are installed as the proximity communication device for each commodity shelf in the store, and a plurality of optical communication IDs are set in the store. Thus, it is possible to grasp the purchase behavior of customer for each commodity shelf.

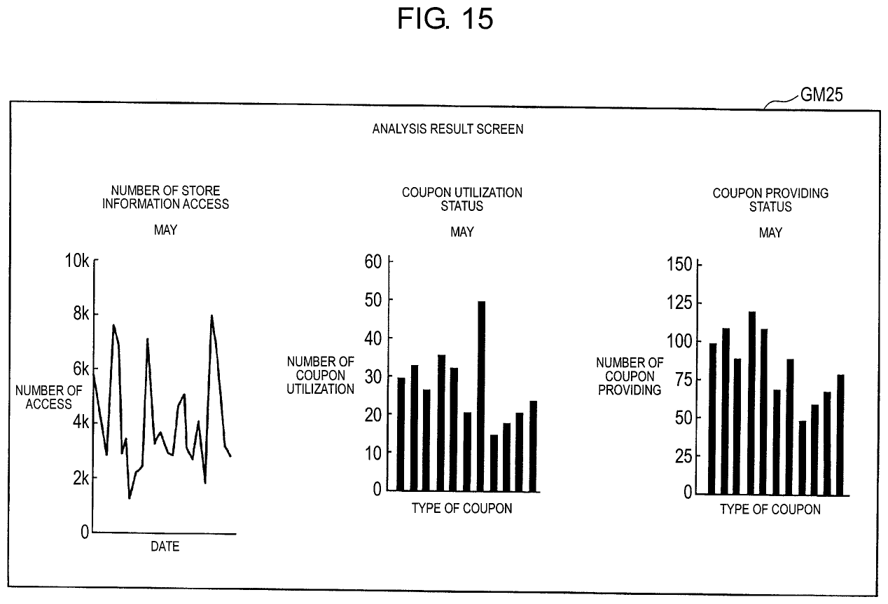

In addition, the number of monthly store information accesses, a coupon utilization status, and a coupon providing status may be displayed as the analysis result screen. FIG. 15 is a view illustrating an example of analysis result screen GM30 including a graph showing the number of store information accesses, a coupon utilization status, and a coupon providing status in May.

For example, when the electronic money is used, the actual result of inactivating the coupon, or the like may be recorded in the log information management DB.

In the above embodiments, the graph displayed in the analysis result screen simply shows the number of utilizations of user, but the number of utilization of user focusing on each attribute such as gender, an age, an address, an occupation, or the like may be displayed. Thus, it is possible to more effectively carry out the measures. Further, a graph showing a conversion rate (a purchase rate and an agreement rate) may be added in the analysis result screen.

### INDUSTRIAL APPLICABILITY

The present disclosure is useful as a server device and an information display method which visually show the analysis result of at least a part of the process such as a time-series behavior of which the plurality of customers purchase or register the commodity or service and enhance the convenience for analysis of the process such as behaviors of the plurality of customers.

### REFERENCE MARKS IN THE DRAWINGS

5 MARKETING SOLUTION SYSTEM
10 PORTAL SERVER
11 TOUCH POINT SELECTOR
12 CUSTOMER JOURNEY SCREEN GENERATOR
13 ANALYSIS RESULT SCREEN GENERATOR
14 DISPLAY SCREEN GENERATOR
15 NUMBER OF NOTIFICATIONS AGGREGATION UNIT
16 NUMBER OF VIEWS AGGREGATION UNIT
17 VISITOR AGGREGATION UNIT
18 PUSH NOTIFICATION SETTING UNIT
19 PUSH NOTIFIER
20 VIEW LOG COLLECTOR
21 VISITOR LOG COLLECTOR
22 COUPON DISTRIBUTION AGGREGATION UNIT
23 COUPON RECEPTION AGGREGATION UNIT
24 COUPON UTILIZATION AGGREGATION UNIT
25 COUPON DISTRIBUTION SETTING UNIT
26 COUPON DISTRIBUTOR
27 COUPON RECEPTION LOG COLLECTOR
28 COUPON UTILIZATION LOG COLLECTOR
30 LOG INFORMATION MANAGEMENT DB
31, 32, 33, 34, 35 COMMUNICATION I/F
40 CUSTOMER COMPANY TERMINAL
41 MONITOR
50 SMARTPHONE
60 TABLET TERMINAL
72 PROXIMITY COMMUNICATION DEVICE
GM1 UI SCREEN
GM2 CUSTOMER JOURNEY SCREEN
GM3 ANALYSIS RESULT SCREEN
TP1 to TP5 TOUCH POINT

1. A server device comprising:
a selector setting a plurality of touch points corresponding to points in time when a plurality of behaviors of a plurality of users who purchase or register a commodity or service in an actual facility occur;
a communicator transmitting information on the commodity or service to a communication terminal carried by each of the plurality of users at at least one of the plurality of touch points;
an acquiring unit acquiring information on a behavior of the plurality of users and information on a behavior of the plurality of users with respect to the information on the commodity or service for each of the plurality of touch points; and
a display screen generator arranging the plurality of touch points in a time series and generating a display screen displaying information on a behavior of the plurality of users for each of the plurality of touch points arranged in a time series, the information on the behavior of the plurality of users being acquired for each of the plurality of touch points and including the information on a behavior of the plurality of users with respect to the information on the commodity or service.

2. The server device of claim 1, wherein the acquiring unit acquires the number of the plurality of users who visit an actual store as the actual facility, as information on a behavior of the plurality of users in association with a touch point corresponding to a point in time when a behavior of the plurality of users who visit the actual store occurs.

3. The server device of claim 2, further comprising:
a second communicator performing communication with an information communication device installed on the actual store and performing short range communication with the communication terminal,
wherein the acquiring unit acquires the number of the plurality of users who visit the actual store based on a result of the short range communication between the information communication device and the communication terminal.

4. The server device of claim 3, wherein the second communicator acquires identification information of the communication terminal transmitted from the communication terminal by the short range communication through the information communication device, and identifies the communication terminal.

5. The server device of claim 1, wherein the acquiring unit acquires information on the number of users who performs a behavior corresponding to each of the touch points as the information on the behavior of the plurality of users.

6. The server device of claim 2, further comprising:
an information notifier performing notification processing of at least guide information on the commodity or service to each communication terminal,
wherein the acquiring unit acquires the number of communication terminals subjected to the notification processing, as the information on the behavior of the plurality of users in association with a touch point corresponding notification processing of the guide information before visiting the actual store.

7. The server device of claim 2, further comprising:
an information notifier performing notification processing of at least guide information on the commodity or service on each communication terminal,
wherein the acquiring unit acquires the number of communication terminals subjected to the notification processing, as the information on the behavior of the plurality of users in association with a touch point corresponding notification processing of the guide information during visiting the actual store.

8. The server device of claim 1, wherein the acquiring unit acquires the number of communication terminals for which utilization processing of discount information on the commodity or service is determined based on a purchase behavior or a registration behavior, as information on a behavior of the plurality of users in association with the touch point corresponding to a point in time when the purchase behavior or the registration behavior of the commodity or service during visiting the actual facility occurs.

9. The server device of claim 8, wherein the acquiring unit further acquires the number of communication terminals for which communication processing is determined based on a stationary behavior for the commodity or service, as the information on the behavior of the plurality of users in association with the touch point corresponding to a point in time when the stationary behavior for the commodity or service during visiting the actual facility occurs.

10. The server device of claim 1, wherein the acquiring unit acquires the number of the plurality of users who visit an actual store as the actual facility, as information on a behavior of the plurality of users in association with a touch point corresponding to a point in time when a behavior of the plurality of users who visit the actual store occur.

11. The server device of claim 1, further comprising:
an information distributor performing distribution processing of at least discount information on the commodity or service on each communication terminal,
wherein the information distributor performs, at any one of the touch points corresponding to a, point in time before visiting the actual facility, either distribution processing of the discount information on the communication terminal or acquisition of identification information on the communication terminal as an object to be subjected to the distribution processing of the discount information.

12. The server device of claim 3, wherein the second communicator acquires, from the information communication device, information on the communication terminal which communicates with an information communication device using at least one of near field communication, two-dimensional barcode reading, and visible light communication as the short range communication.

13. The server device of claim 1, wherein the communicator outputs a setting screen of information on the commodity or service which corresponds to the touch point selected according to a selection operation of any one of the set touch points and is transmitted to the communication terminal by the communicator.

14. An information display method in a server device which is communicable with a communication terminal carried by each of a plurality of users, the method comprising:
setting a plurality of touch points corresponding to a point in time when a plurality of behaviors of a plurality of users who purchase or register a commodity or service in an actual facility occur;
transmitting information on the commodity or service to the communication terminal carried by each of the plurality of users at at least one of the plurality of touch points;
acquiring information on a behavior of the plurality of users and information on a behavior of the plurality of users with respect to the information on the commodity or service for each of the plurality of touch points; and
arranging the plurality of touch points in a time series and generating a display screen displaying information on a behavior of the plurality of users for each of the plurality of touch points arranged in a time series, the information on the behavior of the plurality of users being acquired for each of the plurality of touch points and including the information on a behavior of the plurality of users with respect to the information on the commodity or service.
